(19) United States
(12) Patent Application Publication
(10) Pub. No.: US 2014/0305791 A1
(43) Pub. Date: Oct. 16, 2014

(54) ADDITIVE METALLISATION PROCESS

(71) Applicants: Jack Hoy-Gig Ng, Edinburgh (GB); David Watson, Edinburgh (GB); Marc Desmulliez, Edinburgh (GB); Duncan Paul Hand, Edinburgh (GB)

(72) Inventors: Jack Hoy-Gig Ng, Edinburgh (GB); David Watson, Edinburgh (GB); Marc Desmulliez, Edinburgh (GB); Duncan Paul Hand, Edinburgh (GB)

(73) Assignee: HERIOT-WATT UNIVERSITY, Riccarton,Edinburgh (GB)

(21) Appl. No.: 13/983,192

(22) PCT Filed: Feb. 3, 2012
(86) PCT No.: PCT/GB2012/000116

§ 371 Date: Aug. 1, 2013

(30) Foreign Application Priority Data
Feb. 4, 2011 (GB) 1101907.2

(51) Int. Cl. B01J 19/12

(52) U.S. Cl. CPC B01J 19/127; B01J 19/121
USPC 204/157.41; 204/157.4

(57) ABSTRACT

The invention provides a method of reducing metal ions (3, 204) present on a substrate (100) comprising contacting the metal ions with a material (2, 201, 202) capable of reducing the metal ions to metal atoms (6, 9) upon exposure to visible light, and exposing the material to visible light (1) whereby to generate metal atoms from the metal ions.

### FIELD

The present invention relates to a method of photoreducing metal ions displayed on a surface of a conductive or non-conductive substrate with light having a wavelength in the visible spectrum. Amongst other things, therefore, the invention provides a method of direct metal writing onto non-conductive substrates using visible light lithography.

### BACKGROUND

Many emerging selective metallisation techniques have been directed at simplifying the fabrication steps of metallic structures on various non-conducting substrates. In search of low-cost, simple, direct-metallisation processes without using any vacuum facilities, research has been conducted in to liquid solution and solid coating processes. Direct patterning of metals in a vapour phase environment without using a photomask has been performed for two decades using lasers (K. G. Ibbs and R. M. Osgood, Laser chemical processing for microelectronics, Cambridge University Press, New York, 1989). The substrate is placed in a chamber filled with precursors and buffers whereby scanning of a laser beam induces fast thermal reactions on the substrate for metallisation.

For liquid phase processes, an extensive range of precursors has been published in the literature (K. Kordás at al., “Current trends in depositing and patterning metal films,” in Pulsed Laser Deposition of Optoelectronic Films, 2005, 239-263) using a laser-induced thermal process to decompose a metal compound complexed with organic ligands or ammonia in the aqueous solution, or as a plating enhancement to localise chemical electroless plating. Other efforts have focused on utilising ultra-violet (UV) light energy and its interaction with some photosensitive metal-organic compounds through liquid solution or solid coating to achieve the goal of light-directed patterning of metals without using photoresist materials.

Direct (i.e. additive) metallisation processes are advantageous, since these cut down on raw materials used as compared to subtractive processes in which a metal layer is etched in order to obtain the desired patterns. Proprietary photoresist materials and developer solution are also required in such processes, which increase bottom-line production costs. In recent years, intensive efforts in the development of direct metallisation techniques for microfabrication have thus taken place as a result of the convergence of different fields of science and technology. Direct methods, in contrast to the conventional photolithographic processes, have in common two or more of the following characteristics: (i) they do not require any evaporation techniques or vapour phase chemical precursors, and, thereby, do not need vacuum chambers; (ii) they do not require any photoresist materials; and (iii) they do not require (photo)masks by virtue of their sequential laser writing or ink-jet printing process step.

However, existing techniques have serious drawbacks, including the generation of irregular or oversized features through liquid phase or heat-induced deposition; time-consuming in-house synthesis of metal-organic precursors; and inclusion of organic substances in the final metal deposits. In most cases, narrow, uniform metallic (e.g. copper) patterns with high conductivity (close to that of the bulk) are difficult if not impossible to achieve for a given direct-metallisation route and substrate material. To overcome this drawback, the patterning step is increasingly used to create a localised catalytic surface for consecutive electroless plating. The most frequently deposited seed surface is a palladium thin film or layer made up of nanoparticles. Use of layers of silver nanoparticles as an important catalytic seed layer has emerged recently (see for example A. Vaskelis et al., Electrochimica Acta, 50, 2005, 4586-4591; and S. Schaefers et al., Materials Letters, 60, 2006, 706-709) owing to its lower cost and ease of production.

K. Akamatsu et al. (Langmuir, 2003, 19, 10366-10371) describe application of a thin layer of water to Ag⁺-doped polyimide. UV photolysis is described as creating H• and OH• radicals for photoreduction of the doped Ag⁺ ions using a UV lamp. However the water layer could make the thickness uniformity and thus the Ag⁺ photoreduction difficult to control. In addition, bubble formation within the water layer owing to hydrogen evolution could affect the resolution of the lithographic features. Processing of a liquid coated substrate would also be difficult when combined with the photomask or laser writing setting.

D. S. Chen et al. (Applied Surface Science, 253, 2006, 1573-1580) employed a 266 nm Nd:YAG pulsed laser with a fluence of 3.5 mJ·cm⁻² and repetition rate and pulse duration of 10 Hz and 5 ns, respectively, to achieve Ag⁺ reduction and subsequent electroless Cu plating on polyimide. Ablation which caused undesirable damage on the flexible substrate was reportedly observed although metallic silver was produced. The subsequent electroless Cu plating could in fact be initiated by bond breaking on the etched polyimide (see J. Bekesi et al., Applied Surface Science, 139, 1999, 613-616) and not necessarily on the intended silver particle sites only.

J. H.-G. Ng et al. (Micro & Nano Letters, 2008, 3(3), 82-89) describe the use of a thin film of solid coating containing the photoreactive reducing agent methoxy-polyethylene-glycol (MPEG), which serves as an electron donator, deposited onto a polyimide substrate which already comprises mobile metal ions. The approach is described as permitting UV light patterning, which can achieve higher feature resolution than thermally driven processes; the solid coating is more robust during the processing and handling of substrate; and better feature resolution compared to liquid phase processes. Since mobile metal ions are used as the metal source instead of organometallic compounds complicated synthesis of metal-containing precursors and organic residue in the final metal deposit are both avoided. MPEG is responsive to photons with a wavelength in the UV-range which triggers the metal reduction.

Use of directed light sources in processes such as those described above to induce photoreduction of metal ions on a substrate directly eliminates the use of photoresist materials, cuts processing steps and also allows in principle maskless photolithography which can dramatically reduce time in the design-to-prototype cycles. However these metallisation approaches describe use of photon energies in the ultraviolet (UV) wavelength range. Such high energy photons can cause undesirable damage or degradation to the substrate for the metallisation, especially organic materials used for flexible circuits or organic coatings for insulation between layers in a microsystem package. Despite high photon energies at the short wavelengths of UV light direct UV metallisation processes can have low yield and require a long period of time to produce usable amount of metal aggregates. In addition high-power UV light sources are both expensive and not necessarily readily available. Such processes are therefore generally unsuitable for use in an industrial environment. Moreover the long beam exposure results in the degradation of the substrate, an undesirable consequence in terms of subsequent metal plating adhesion.

J. P. Bearinger et al. (Molecular & Cellular Proteomics, 2009, 8, 1823-1831) describe the use of magnesium phthalocyanine (MgPC) as a photosensitiser. This was coated on a poly(dimethylsiloxane) (PDMS) mask that was placed in contact with a substrate of, for example silane-coated silicon. Upon irradiation with a visible light source through the PDMS mask, the MgPC beneath the PDMS mask absorbed the photon energy and generated reactive oxygen radicals in its vicinity. These radicals in turn are described as selectively oxidising the silane on the substrate. The oxidised silane was then removed, and the remaining silane patterns were grafted with other functionalized polymers such as thiols, or sulfides for subsequent adsorption of biomolecules, for example proteins and cell culture. No molecules other than biomolecules are described as having been applied as target materials in this method.

In the work described by J. P. Bearinger et al., photoinduced electronic excitation from MgPC was used to form reactive oxygen radicals by charge separation. By inducing selective oxidation on the silane layer to form removable silane patterns, the silane layer effectively acts as a photoresist material, participating in a subtractive patterning process. A disadvantage of the process described is that a master mask is required—this was produced by electron beam lithography, an expensive and time-consuming process. The process also relied on the successful substrate silanisation to form the first adhesion polymer layer. In addition, further functionalised polymer grafting onto the patterned silane is required to adsorb the target materials. This increases the number of process steps.

Accordingly, existing methods of substrate metallisation, particularly of non-conductive substrates and/or in the fabrication of components for microelectronics and the like are deficient and the present invention is intended to address one or more of the existing deficiencies in the art.

### SUMMARY

Surprisingly we have found that light in the visible spectrum may be used to allow reduction of metal ions displayed on the surface of a substrate, by making use of a material capable of generating electrons upon exposure to visible light, whereby to generate metal atoms on the surface of the substrate. The use of visible light confers a number of advantages, not least the avoidance of damage to the substrate resultant from the use of UV light.

The use of visible light harvesting agents to release electrons for reduction of metal ions on the surface of substrates, to provide for deposition of a metal layer, is believed to be a novel concept in the field of materials science, particularly microfabrication, and allows realisation of additive, selective and facile microfabrication techniques on a wide variety of substrate materials. The present invention thus provides a photolithographic method, which can be maskless, using a visible light-harvesting chemical agent as a coating and a light source in the visible region of the spectrum.

The present invention utilises a methodology inspired by biological systems that generate excited electrons by photoexcitation, such as those which occur in the antennae of photosystems in plants for photosynthesis, for effecting metallisation, particularly in micro- and nano-technology. Energy harvested from visible light, in the form of electrons or radicals, is used for the reduction of free metal ions on a substrate in order to metallise substrates in an additive and selective manner.

Viewed from one aspect, therefore, the invention provides a method of reducing metal ions present on a substrate comprising contacting the metal ions with a material capable of reducing the metal ions to metal atoms upon exposure to visible light, and exposing the material to visible light whereby to generate metal atoms from the metal ions.

Viewed from a second aspect, the invention provides the use of a material, capable of reducing metal ions in contact with the material when exposed to visible light, in the reduction of metal ions on a surface of substrate.

Viewed from a third aspect, the invention provides a substrate obtainable according to the first or second aspect of the invention.

Further aspects and embodiments of the present invention will be evident from the discussion that follows below:

### BRIEF DESCRIPTION OF THE FIGURES

FIG. 1 depicts, schematically, a pathway by which photoexcited electrons reach metal ions on a substrate to effect their reduction.

FIG. 2 depicts the photoreduction of metal ions into metal particles.

FIG. 3 shows a substrate comprising photoreduced metal ions, after washing away of a layer material capable of reducing the metal ions to metal atoms upon exposure to visible light, leaving intact the metal ion source layer and regions of photoreduced metal ions.

FIG. 4a shows regions where metal ions were previously doped, after washing with a dilute acid solution. FIG. 4b shows the substrate after an annealing step in which the previously modified surface layer has been restructured to its original chemical form and the metal particles in FIG. 4a have agglomerated into denser and bigger aggregates.

FIG. 5a shows regions where metal ions previously attached to the substrate 4 by linkers have been washed away by a dilute acid solution. FIG. 5b shows the substrate after an annealing step in which the previously linker-containing region has been burnt away and metal particles in FIG. 5a have agglomerated into denser and bigger aggregates.

FIGS. 6a and 6b depict a plated metal layer on top of the metal particles after an electroless plating process.

### DETAILED DESCRIPTION

The invention relates to a controllable method of reducing metal ions present on a substrate, i.e. to the reduction of metal ions displayed on a surface of an underlying bulk layer, whereby to pattern the surface with regions of metal atoms in desired locations. There is no particular limit to the substrate material on which the metal layer may be generated. For example, the method can be applied to the microfabrication of metallic structures on a wide variety of technologically important substrate materials where incorporation of metal ions on the surface of these materials is possible. Examples include silicon, glass, printed circuit boards (PCB), ceramics, polymers, for example non-conductive organic polymers such as polyimide, PDMS, PET, BoPET (e.g. Mylar), PMMA, polyamides (e.g. nylon), PTFE, liquid crystal polymer (LCP), photoresist resins such as SU-8, or other epoxy materials.

The polyimide may be a modified polyimide, for example a poly(etherimide), poly(amideimide), poly(esterimide), poly(etherimide) or poly(imide-carbonate). According to particular embodiments, the polyimide is a poly(etherimide). Two specific examples of poly(etherimide)s used commonly are (i) the polymer poly(4,4′-oxydiphenylene-pyromellitimide), which is frequently referred to as “polyimide” or “PI” and sold under the trade name Kapton; and (ii) the thermoplastic frequently referred to as “polyetherimide” or “PEI”, having CAS number 61128-46-9 and sold under the trade name Ultem for various applications.

Poly(etherimide)s, such as PEI, have excellent thermal and chemical resistance and mechanical strength, are good dielectric materials, have high rigidity, even at elevated temperatures, are inherently flame resistant and low smoke generating and can be mixed into a variety of colours. Current applications include light cluster housing in the automotive industry and as wire insulators on aeroplanes.

Poly(etherimide)s, such as PEI, are commonly processed via injection moulding, a major part of the emerging production technology of moulded interconnect devices (MIDs). Accordingly, the present invention using polyetherimide substrate may be applied to the 3D direct laser writing of MIDs. This adds to poly(etherimide)s' compatibility with reel to reel processing (in its sheet form), further increasing their potential.

The method by which the metal ions, which are to be subsequently reduced, are initially displayed on the substrate is not of particular importance and the skilled person is aware of various ways in which this can be done. For example, metal ions can be incorporated by ion-doping into a thin layer of the substrate surface (“the ion-doping method”). This is commonly achieved by chemical surface-modification step. A second approach (“the linker method”) involves the use of a layer of linker molecules, where one end of the linker is rigidly attached to an optionally surface-modified surface of a substrate. By choosing an appropriate type of linker molecule, its unattached end can adsorb metal ions, in particular those which show strong affinity to the particular molecular structure. For example, gold ions may be adsorbed in this way onto silica substrates with the use of silane linkers. Other methods are known in the art.

According to particular embodiments of the present invention, the substrate is a non-conductive polymer, such as polyimide or PDMS. For example, the polyimide may be a poly(etherimide), such as PI or PEI. According to these and other embodiments, the substrate is initially chemically treated. This has the advantage of embedding the metal ions, to a controllable degree, into the substrate, rather than simply providing a coating of metal ions on the surface of the substrate. This is believed to improve the adhesion of the subsequently reduced metal to the substrate.

Polyimide is a particularly important flexible substrate in microsystems technology owing to its many desirable properties such as low dielectric constant (low-k), high mechanical strength, high resistance to moisture (2.8% over 24 hrs at 23° C. ASTM D570) and heat (T_{g}=365° C.), chemical inactivity as well as biocompatibility. An ion-exchange process using a metal hydroxide (typically potassium hydroxide) to incorporate metal cations into surface-modified polyimide substrates has become the starting procedure to provide metal ion-doped surfaces for extensive research into metallisation methods in the last few years. The resultant mobile metal ions from the ion-exchange are advantageously confined within the top amorphous layer of the surface-modified substrate.

Typically the polyimide, e.g. poly(etherimide), such as PI or PEI, will be an aromatic polyimide, in which the imide functionality is contained in a cyclic region within the polymer chain. Such structures are advantageous since severage of one of the N(H)—C(O) bonds of the cyclic imide allows substrate functionalisation, by either the ion-doping or linker methods, typically the ion-doping method. The skilled person is well acquainted with polyimides, e.g. poly(etherimide)s such as PI and PEI, suitable for this purpose.

Silver ions may be incorporated by introduction of a suitable silver salt (e.g. silver nitrate). However, the characteristic photoreduction method of this invention may also be applied to other metal ions, such as copper, gold, nickel, iron, tin or palladium ions, or mixtures thereof; and, or to provide coatings of alloys, e.g. comprising aluminium, zinc, tin, lead or magnesium. Magnetic coatings may also be generated.

After preparation of the desired substrate, displaying metal ions on a surface thereof, a layer of the material capable of reducing the metal ions to metal atoms upon exposure to visible light, hereinafter referred to as the visible light-activated photocatalyst, is coated. This coating may be achieved, at atmospheric pressure, by any convenient method, for example by doctor-blading, meyer bar or wire wound rod, spraying, printing or spin-coating onto the layer or region(s) of displayed metal ions. The visible light-activated photocatalyst may be applied as a solution in any convenient solvent, e.g. an alcoholic solvent such as ethanol.

Typically, although not necessarily, complete coverage of the metal ion-displaying or -containing substrate is effected. Typically the thickness of this layer will be more than about 0.5 μm, e.g. more than 1 μm, up to about 10 μm, in order to achieve appropriate light absorption by the visible light-activated photocatalyst. An example of a typical layer thickness is between about 4 and 6 μm.

A key distinguishing feature of the present invention in comparison with the prior art is the use of visible, as opposed to UV, light to effect the desired photoreduction of metal ions by exposure of the visible light-activated photocatalyst to visible light, usually light having a wavelength between about 390 nm and 700 nm.

The present invention is based on the demonstration that photoexcited electrons can be successfully transferred from a coating of a visible light-activated photocatalyst to on a substrate displaying metal ions incorporated into or on a substrate thereof. Whilst not wishing to be bound by theory some considerations will now be described in terms of a mechanism for this.

Visible light-activated photocatalysts, such as the light-harvesting pigments found in plants, absorb light energy in the visible region of the spectrum. The absorbed energy excites certain electrons from the pigment molecules into a higher energy state. The excited electrons can then be quenched by neighbouring electron recipients, whereby the excited charge is separated from the pigment molecules. This electron transfer process occurs within a very short time (up to picoseconds) and at a very short length scale (up to about 1 nanometre) (see D. Noy, et al., Biochimica et Biophysica Acta-Bioenergetics, 1757, 2006, 90-105). Notably, the present invention is based on the demonstration that photoexcited electrons can be successfully transferred from a coating of a visible light-activated photocatalyst to on a substrate displaying metal ions incorporated into or on a substrate thereof.

Experiments carried out in the present invention have proven the high efficiency of the visible light-activated photocatalyst in the context of generating reducing agents for the reduction of metal ions by light absorption. This indicates that the electrons used for metallisation have traveled from the photoreceptor (visible light-activated photocatalyst molecules) to the final destination (metal ions), a distance of at least hundreds of nanometres. The transfer mechanisms involved are likely to be attributable to those that operate in the photocatalytic systems that operate in plants.

Natural evolution has provided complex photosynthetic proteins, including molecules that comprise visible light-activated photocatalysts useful according to the present invention, which are capable of transferring electrons in an energy conversion relay (L. Sepunaru et al., Nano Letters, 9, 2009, 2751-2755), where the photoexcited electrons are passed onto a series of receptors over a long length scale. Chloroplasts, for example, comprise thylakoids: membrane-bound compartments that contain photosystems I & II, which are made up of visible light-activated photocatalysts such as chlorophyll, beta-carotene. Thylakoids are also found elsewhere, for example in cyanobacteria. Thus, in some embodiments, the material capable of reducing the metal ions to metal atoms upon exposure to visible light may comprise thylakoids themselves. In other embodiments, the material capable of reducing the metal ions to metal atoms upon exposure to visible light will be a purified form of the visible light-activated photocatalysts and these are now discussed.

The nature, i.e. the structure of the visible light-activated photocatalyst is not particularly important: since it is the functional—activation with visible light—rather than structural properties of the photocatalyst that are important, and the skilled person is aware of a wide variety of, in some cases, structurally diverse, compounds that possess visible light-induced photocatalytic reducing functionality (see for example G Calogero et al. (Energy Environ. Sci., 2009, 2, 1162-1172) in which the use of chlorophyll and related compounds as sensitisers in photoelectrochemical cells is described).

The skilled person is aware of the many naturally derived visible light-harvesting components, i.e. photosynthetic pigments, found in plants, algae or bacteria, exert photocatalytic reducing ability during photosynthesis. Such photosynthetic pigments, the word pigment defining a compound that absorbs a proportion of visible light, in either highly or even crudely purified form, may be used in accordance with the present invention.

Examples of such naturally derived photosynthetic pigments include compounds having cyclic or acyclic structures comprising a highly conjugated chromophore.

The principal examples of acyclic, naturally derived, visible light-harvesting photosynthetic pigments are the carotenoids and the phycobilins. Carotenoids are a large series of naturally occurring tetraterpenoid organic pigments that may be hydrocarbons (carotenes) or hydroxyl-containing organic compounds (xanthophylls). With their hydroxyl groups, xanthophylls are more polar than carotenes, which can be advantageous (they can, for example, be applied or removed in aqueous or water-based solutions). Phycobilins are a series of acyclic compounds comprising four pyrrole units found in certain algae such as cyanobacteria and rhodophyta (although not in green algae or higher plants).

There are many examples of cyclic, naturally derived, light-harvesting photosynthetic pigments. However, these may mostly be classified as chlorophylls; greenish-coloured pigments, which absorb visible light having a wide variety of wavelengths but not in the central region of the visible spectrum encompassing green light. They are a critical component of the photosynthetic machinery of green plants, bacteria and algae. Chlorophylls may be described generally as magnesium (II) salts of chlorins, a chlorin ring being made up of three pyrrole and one pyrroline (3,4-dihydropyrrole) moieties linked by four methine (—C(H)═) bridges, each of the pyrrole and pyrroline moieties being connected at its 2- and 5-carbon atoms to an adjacent pyrrole or pyrroline moiety through a methine biradical.

Chlorophylls typically differ from one another in the nature of the substitution of the chlorin ring, particularly with regard to the presence or absence of a long hydrophobic phytol-derived chain. The most predominant examples of chlorophylls are chlorophyll a and chlorophyll b. However, others are known, including chlorophyll c and chlorophyll d.

There are many structural variations of chlorophylls, some occurring naturally, some having been made by synthetic modification of natural chlorophylls or variants thereof. For example chlorophyllins are well-documented, water-soluble copper-based chlorophyll derivatives. Other chlorophyll derivatives include compounds resultant from hydrolysis of a phytol-derived side chain and/or substitution of the Mg (II) ion for a different metal ion, such as zinc (II), nickel (II) or copper (II). Pheophorbides are resultant from treatment of chlorophylls (or chlorophyllins) with hydrochloric acid. Pheophytins, which are chlorophylls absent the magnesium atom, whilst less effective photosensitisers as compared with the corresponding chlorophylls (see G Calogero et al. infra), are nevertheless not ineffective photosensitisers and may be used in accordance with the present invention.

In addition to the chlorophylls (and other chlorin-based compounds, including those discussed infra), there a variety of other macrocyclic compounds based either on four pyrrole or reduced pyrrole units linked either through methine or imine (—N═) bridges, that may be used as visible light-activated photocatalysts according to the present invention. For example, porphyrin rings comprise four pyrrole moieties linked by four methine bridges, each of the pyrrole moieties being connected at its 2- and 5-carbon atoms to an adjacent pyrrole moiety through a methine biradical. Corrin rings comprise four pyrroline moieties linked by three methine bridges, all but one of the pyrroline moieties being connected at its 2- and 5-carbon atoms to an adjacent pyrroline moiety through a methine biradical; two of the pyrroline moieties, however, are directly connected, from the 2-carbon of one to the 5-carbon atom of the other. Phthalocyanines are macrocycles comprising four pyrrole-based five-membered rings linked by four imine bridges, each of the five-membered rings having a benzene ring fused to the 3- and 4-positions of the five-membered ring, and each of the five-membered rings being connected at its 2- and 5-carbon atoms to an adjacent five-membered ring through an imine biradical. Notably, the utility of magnesium phthalocyanine itself has been described by Bearinger et al. (infra) in facilitating what is referred to as porphyrin-based photocatalytic nanolithography, by the (subtractive) oxidation of a layer of silane.

From the foregoing discussion, it will thus be appreciated that there are a large number of visible light-activated photocatalysts, both naturally derived (such as chlorophylls), purely synthetic (such as phthalocyanines) or compounds resultant from synthetic modification of natural products, e.g. of the chlorin ring in chlorophylls, for example by hydrolysis of a phytol-derived side chain and/or by virtue of the presence of a different metal ion, such as zinc (II), nickel (II) or copper (II), that are both known and readily accessible to those skilled in the art. See, for example, the discussions of appropriate molecules by Calogero (infra) and by J. W. Fahey et al. (Carcinogenesis, 2005, 26(7), 1247-1255). Moreover, owing to the abundance of chlorophylls and related compounds, particularly chlorophyll a, in broad-leaved green plants, extraction is readily achievable by the skilled person (an embodiment of the invention is exemplified below in which chlorophyll a is extracted from spinach leaves with ethanol).

The definition of the visible light-activated photocatalyst herein as “a material capable of reducing the metal ions to metal atoms upon exposure to the visible light” is entirely commensurate with the nature of the invention, a skilled person having no difficulty in selecting appropriate material using his common general knowledge and appreciating, as illustrated by the foregoing discussion, that other means could be used for the same function. It is nevertheless possible to define particular materials with regard to well-understood structural features. Thus, for example, the visible light-activated photocatalyst may be, according to certain embodiments, either an acyclic or cyclic visible light-harvesting pigment. The pigment may be naturally or synthetically (i.e. unnaturally) derived.

Alternatively, the visible light-activated photocatalyst may be a partially synthetic visible light-activated photocatalyst, for example provided by taking a naturally dried pigment and effecting one or more chemical transformations to it (e.g. hydrolyses, esterifications, amidations or combinations of these).

According to particular embodiments of the invention, the visible light-harvesting photocatalyst is a compound comprising a tetrapyrrole-containing compound. By “tetrapyrrole-containing compound” is meant herein a compound comprising four pyrrole rings or reduced forms thereof (such as the pyrroline ring found in the chlorin ring within chlorophylls). This nomenclature (i.e. use of the term tetrapyrrole-containing compounds to embrace compounds not necessarily comprising four pyrrole rings) is consistent with the use prevalent in the art to describe as tetrapyrrole compounds such as phthalocyanines and chlorophylls even although these compounds, strictly speaking structurally, do not comprise four pyrrole rings.

It will be understood from the foregoing discussion, therefore, that the term tetrapyrrole-containing compounds is intended to embrace both acyclic photosynthetic pigments such as phycobilins, as well as macrocyclic compounds or salts thereof, such as chlorins, corrins, phthalocyanines, as well as porphyrins (which are made up of four pyrrole moieties linked through their two- and five-carbon atoms by methine bridges; the archetypal member being haeme), for example, chlorophylls, pheophorbides, chlorophyllins and pheophytins.

According to particular embodiments of the invention, the visible light-activated photocatalyst is a salt, typically a metal (II) salt, for example, a magnesium, nickel, copper or zinc (II) salt, typically magnesium (II) salt of a macrocyclic tetrapyrrole-containing compound. For example, such photocatalysts may be such metal salts of chlorins, porphyrins, phthalocyanines or corrins. According to particular embodiments of the invention the visible light-activated photocatalyst comprises either a free chlorin (e.g. a pheophytin) or a chlorin complexed to a magnesium, zinc, nickel or copper salt, in particular a magnesium (ii) salt, of a chlorin. In particular embodiments of the invention, therefore, the visible light-activated photocatalyst is a chlorophyll, e.g. chlorophyll a or b, in particular chlorophyll a.

After coating with the visible light-activated photocatalyst, photopatterning, whereby to generate the desired regions of metal atom layer, is carried out. This may be achieved by using either a light source directed through a photomask to produce the illumination of an image, or by utilising a laser, e.g. as part of a computer-controlled laser scanning system, to produce the desired patterns. The latter may be referred to as direct laser writing. The light source can either be an incoherent light source that emits a range of wavelengths including wavelengths at which the visible light-activated photocatalyst can absorb efficiently, or a laser with a specific wavelength that the visible light-activated photocatalyst is known to absorb efficiently.

The wavelength of the light source or laser is advantageously selected on the basis of the absorption spectrum of the nature of the visible light-activated photocatalyst. For example, for a chlorophyll coating, irradiated light will typically have wavelengths of 470 nm and below in the blue and purple regions of the spectrum, or of around 650 nm-675 nm in the red region. Typically, with tetrapyrrole-containing compounds, light with wavelength band maxima in the blue and purple regions of the visible spectrum (about 380 to 500 nm, e.g. about 430 to 480 nm) are used.

The power density of the light source can be adjusted as required. If using a photomask setup, for example when exposing, or “flooding”, the entire surface with light as is already done in PCB manufacture, a minimum power of around 30 mW·cm⁻² will typically be used, e.g. in the region of above 1 W·cm⁻² or up to about 500 W·cm⁻² where high-throughput processing is desirable. Photomask exposure time, if a photomask is used, should be 5 minutes or less, preferably 1 minute or less, to provide significant commercial benefit.

Where a laser is used, its spot size may be about 1000 μm or lower, for example, less than 1 μm. In some cases the spot size may approach the diffraction limit of the laser system, a function relating to wavelength and aperture size ((1.22×wavelength)/aperture). The output power of the laser is typically at least 50 mW. Higher powers in the region of 100 mW to 1 W are feasible, providing the power density does not exceed a threshold where thermal degradation of the substrate occurs owing to excessive localised heat generation, something that may be readily controlled. Laser scanning speed is typically more than 1 cm·s⁻¹, e.g. 30-50 cm·s⁻¹, or faster.

The ability to directly pattern, or “direct write”, circuits, interconnections or sensor components onto films or coatings of technologically important substrates, e.g. non-conductive polymeric substrates such as polyimide, e.g. a poly(etherimide) such as PI or PEI, is of particular benefit and allows access to more compact and lighter weight products, into which more complex conformal structures can be engineered achievable through manufacture involving fewer steps. With the flexibility that this technology offers (line width, three dimensional metal lines), greater innovation of products is possible by freeing the technical constraints imposed by traditional deposition techniques. Also, with a broad range of regions in the visible spectrum available for photolithography, the present invention allows very advantageous flexibility in optical configurations. The extended range of wavelengths and power densities available can allow clever optical techniques such as two-laser interference and other techniques using various apertures or photomasks such as holographic masks to produce metallic structures with ultra-fine feature resolution or/and high throughput volume.

No evaporation techniques are required in the entire process and, together with the advantage of the ability to carry out the photopatterning step in atmosphere of air, the present selective metallisation process can then be applied with ease on contoured or other 3-dimensional surfaces.

Table 1 below compares an embodiment of the present invention, with prior art methods:

| | (2003) Akamatsu | (2008) Ng | Present |
|---|---|---|---|
| | et al. (infra) | et al. (infra) | invention |
| Assisting | Water | MPEG | Chlorophyll |
| coating | | | |
| used | | | |
| Wavelength | 315 nm (main) | 250-450 nm | 470 nm |
| Incident | 260 mW · cm⁻² | ~50 mW · cm⁻² | 43 mW · cm⁻² |
| irradiation | | | |
| intensity | | | |
| Minimum | 60 minutes | 90 min (270 J) | 10 minutes |
| exposure | | 240 min (720 J) | |
| time | | | |
| Energy dose | 936 J | | 26 J |
| Substrate | Ion loading | 5 times less than | 5 times less than |
| condition | sufficient | Akamatsu et al. | Akamatsu et al. |
| (ion | to form a | | |
| loading | conductive | | |
| level) | film | | |
| Photo- | 50-100 nm) | Sufficient to | Sufficient to |
| reduced | conductive | initiate elec- | initiate elec- |
| silver | silver layer | troless plating | troless plating. |
| and | produced with | for production | Bright reflective |
| comments | high resistance. | of a thicker | silver appearance |
| | No subsequent | conductive top | more prominent |
| | electroless | metal layer. | than that from Ng |
| | plating | However the | et al. using 240 |
| | demonstrated. | adhesion of such | minutes' exposure. |
| | | top metal layer | Top metal layer |
| | | was very poor. | adhesion improved. |

The energy dose required in the present invention is dramatically lower than prior art and allows for production of bright, reflective silver patterns. It is 36 times lower than that of Akamatsu et al. and over 27 times less than the preferred time (240 minutes) of Ng et al. A direct comparison cannot be made with Akamatsu et al. since the ion loading in that was 5 times higher, and no electroless plating was performed there.

The use of electrons or radicals released from the photoreactions initiated by the visible light-activated photocatalyst therefore clearly increases the process yield of photoreduction of metal ions compared to the UV photoreduction processes in the related art where only a narrow band of light in the UV wavelength could be harvested. Furthermore, much higher power light sources in the visible region are readily available at relatively much lower costs. Thus the present invention allows increase in process yield with much wider input parameter windows in terms of the wavelength and the power of the light source used.

Moreover, degradation of substrate due to high dose of UV irradiation is minimised or/and even eliminated. Since the photoreduction of metal ions requires a higher light dose compared to other microfabrication processes such as cross-linking of photoresist, the degradation of the polymer substrates due to photolytic dissociation of chemical bonds by prolonged UV irradiation can arise. Therefore the maximum power that can be used is limited to the threshold of photolytic damage, which is low for UV light but is higher for visible light. The efficiency of generating metal products by photoreduction for UV light sources is therefore very low if one wishes to maintain the integrity of the substrate. The resultant metal-coated substrates are thus distinguished from prior art substrates prepared using UV light.

There is a relationship of increasing irradiation intensity and minimising exposure time. Thus by increasing the irradiation intensity, exposure time can be reduced. By increasing irradiation intensity to values in the region of 500 mW·cm⁻² or 1 W·cm⁻², which are attainable values for light sources in the blue (e.g. 470 nm) wavelength, exposure times can be reduced to particularly short and commercially useful durations.

After photoreduction, the visible light-activated photocatalyst can be easily washed away with a suitable solvent, in many cases water, leaving intact the unreduced regions of the initial layer of metal ions and the regions of elemental metal resultant from photoreduction of the metal ions.

Two different process steps are typically conducted after this process step (removal of the visible light-activated photocatalyst). Firstly, unreduced metal ions may be washed away with an appropriate amount of dilute acid solution. Secondly, an annealing step (discussed below) may then be effected. If the linker method was used, unreduced metal ions can be washed away by a dilute acid solution. This, however, will leave the surface with the linker molecules displayed.

Neutral metal atoms formed by the photoreduction will typically spontaneously nucleate and thereby grow to become larger particles, e.g. to provide seed layer of metal nanoparticles. Electroless plating (e.g. of copper) may be then, and typically is, conducted to achieve thicker conductive tracks. Using a suitable metal ion loading in the substrate may be used to provide a thin conductive silver layer by photoreduction only.

In many instances, it is advantageous to effect an annealing step after the photoreduction, prior to electroless plating if conducted. This can serve two main functions: (1) it serves to agglomerate further the metal particles formed by photoreduction, into denser and bigger aggregates, to provide a better catalytic surface, or seed layer, for subsequent electroless plating (if desired); and (2) to increase adhesion between the metal particles and the substrate. Additionally, annealing can also serve to restructure the modified layer of the substrate to its original chemical form, for example by reforming the cyclic imide structure (reimidising) within aromatic polyimides (including aromatic poly(etherimide)s) such as PI or PEI. Where the linker method has been followed, annealing can also serve to burn away exposed linker molecules (although these may be desirable to maintain on the surface of the substrate, e.g. for refunctionalisation). Care should be taken to avoid over-annealing; this can cause thermal degradation of the substrate, especially organic substrates. However, such care is well within the ability of those of skill in the art.

Annealing may be achieved by heating, e.g. at a temperature of between about 50° C.-200° C. for between about 1 h and 24 h. The most appropriate heating regimen can be readily determined by the skilled person.

Advantageously, therefore, by an annealing step or otherwise, a sufficient density of metal particles is provided on the substrate to increase the reliability of a subsequently electrolessly plated top metal layer. To achieve this, in part, the density of the metal particles provided by photoreduction of the metal ions can be increased by routine trial and error by, for example, increasing dose of light energy applied and/or increasing the quantity and/or concentration of the initial layer of metal ions on the substrate.

Subsequent electroless plating, typically of copper or silver, may be conducted in accordance with procedures with which the skilled person is familiar. For example, several different formulations of electroless copper baths are described by J. H.-G. Ng et al., (Circuit World, 35, 2009, 1-17) as having been tested for the deposition of copper onto a silver catalytic seed layer.

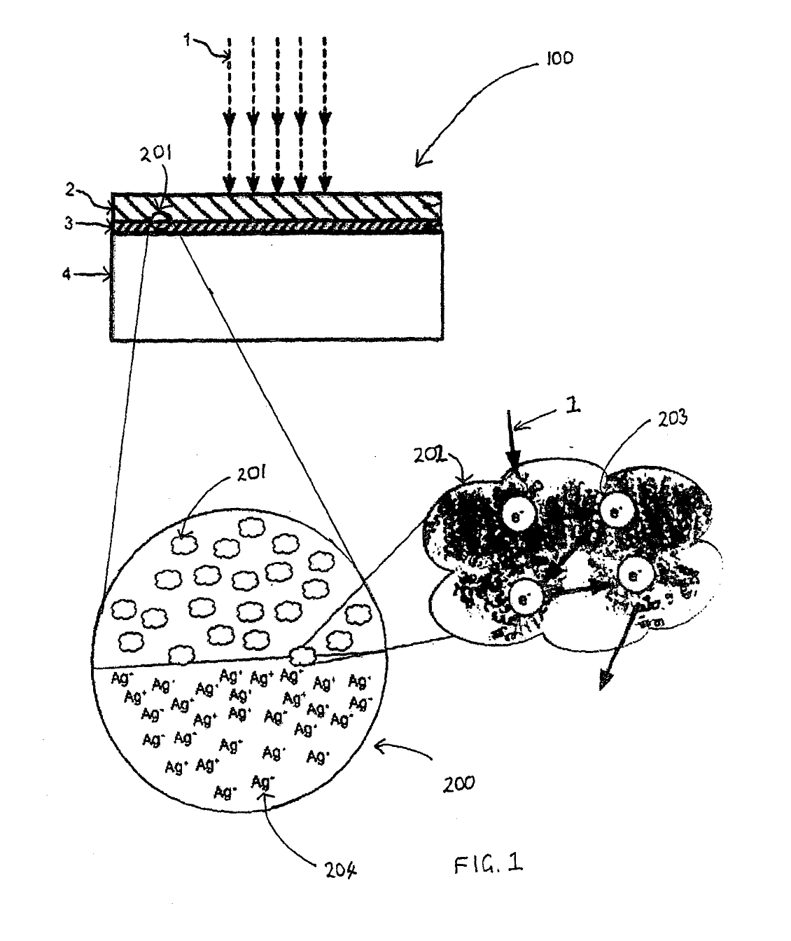

The invention may be further understood with reference to FIGS. 1 to 6 in which a particular embodiment of the present invention is depicted.

FIG. 1 depicts, schematically, visible light (1) impinging upon a coating of visible light-activated photocatalyst (2) layered on a coated region (3) of polyimide substrate (100), region (3) being doped with silver ions. Expanded region (200) depicts, again schematically, an interface region (201) of Ag⁺-doped region (3) and undoped region (4). Within expanded region (200) are depicted individual molecules (201) of visible light-activated photocatalyst. These are expanded (202) and shown receiving visible light (1) and releasing electrons (203), which reduce silver ions (204) to silver atoms.

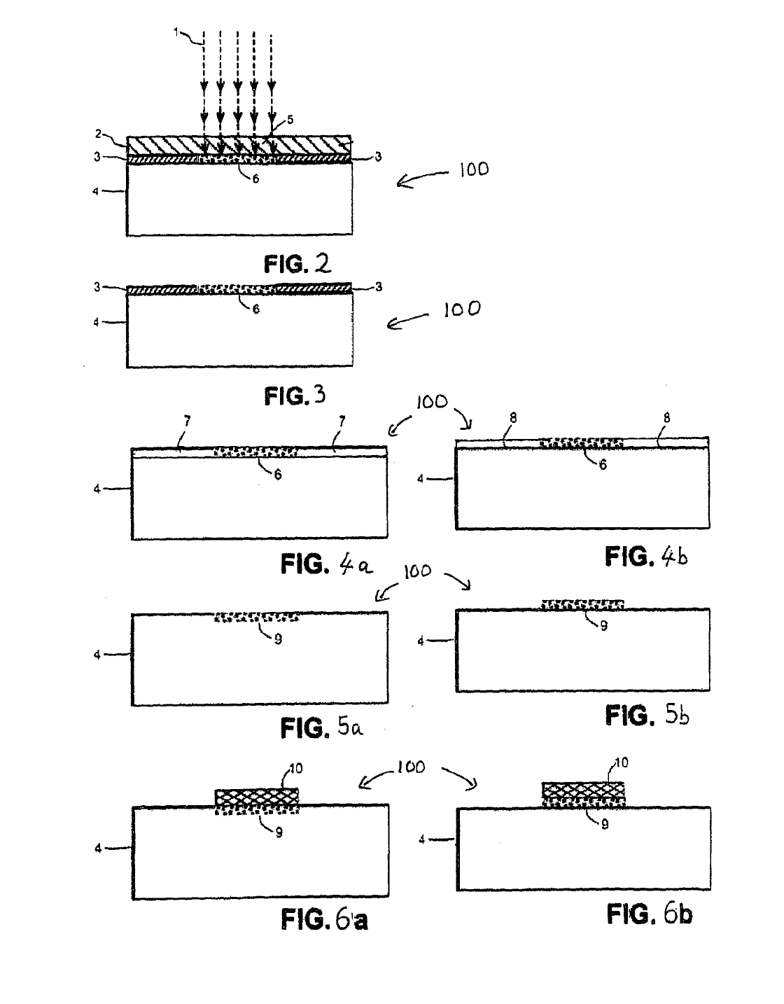

FIG. 2 depicts, schematically, coated polyimide substrate (100) with visible light (1) impinging upon region (5) of a coating of visible light-activated photocatalyst (2) layered on an Ag⁺-doped region (3) of the coated polyimide substrate (100). This serves to reduce the silver ions within region (6) of doped region (3) to silver atoms.

FIG. 3 shows coated polyimide substrate (100) after washing away the visible light-activated photocatalyst layer depicted in FIG. 2, and leaving intact the Ag⁺-doped regions (3) and silver atom-containing region (6).

FIG. 4a shows regions (7) of coated polyimide substrate (100) where metal ions were previously doped, after washing away with a dilute acid solution. FIG. 4b shows coated polyimide substrate (100) after an annealing step in which regions (7) depicted in FIG. 4a have been restructured (re-imidised) to that of undoped region (4). The silver atoms of region (6) depicted in FIG. 4a have agglomerated into denser and bigger aggregates (9).

FIG. 5a shows regions (8) comprising linker molecules of coated polyimide substrate (100) where metal ions previously attached to the linker molecules have been washed away by treatment with a dilute acid solution. FIG. 5b shows the coated polyimide substrate (100) after an annealing step in which the previously linker-containing regions (8) have been burnt away and the silver atoms of region (6) depicted in FIG. 5a have agglomerated into denser and bigger aggregates (9).

FIG. 6a depicts the substrate of FIG. 4b after electroless plating of metal layer (10) onto aggregates (9).

FIG. 6b depicts the substrate of FIG. 5b after electroless plating of metal layer (10) onto aggregates (9).

Thus, the present invention provides an additive and selective metallisation process onto conductive or non-conductive substrates. Of particular note is the improvement in the yield achievable in metallisation from ion-doped polyimide and other metal-ion incorporated substrate materials.

The invention also provides an improvement in the field of photolithography, with an additive approach with fewer process steps and fine feature resolution compared to the current subtractive photoresist moulding or mechanical printing approaches. Unlike traditional electrodeposition techniques, which require a seed conductive layer, no seed conductive layer is needed according to the method of the present invention.

By employing an efficient light-harvesting coating, the visible light-activated photocatalyst, and a light source in the visible spectrum which solves the problem of UV degradation to the substrate, and low yields of photoreduction found hitherto with the use of UV light. In addition, higher power visible light sources are significantly cheaper than UV light sources. This in turns allows a much wider process parameter window for applications.

The technology minimises fabrication steps and maximises throughput. Thus turn-around time can be reduced allow mass customisation and high-value manufacturing. Also reduction of the cost of raw materials (by reducing or eliminating subtractive processes), and avoidance of the need of proprietary and/or costly products such as photoresist resins and developer solutions, or a seed conductive layer, brings further benefit. The metallisation process of this invention can also occur at atmospheric pressure and in a dry environment. Through the use of a direct laser-writing of metal interconnects at atmospheric pressure and in a dry phase, the technology of the present invention can be introduced into reel-to-reel manufacturing lines allowing further reduction in manufacturing costs. In addition, significant cost saving for companies can be realised in prototyping. For example, by using a computer-controlled laser scanning system for direct writing, no physical masks are required. This accelerates the design-to-prototype cycles of products whilst reducing the cost in the prototyping stage.

The invention has application in the manufacture of microsystems, microelectronics, materials science, semiconductor manufacturing, printed electronics, and flexible substrates, for example in circuit production, advanced interconnection and packaging, as well as in a broad range of sensor applications including electromagnetics and bio-sensing.

Of particular note is the application of the invention to microfabrication. The market trend to miniaturise technology, particularly of electronics does not only require increased density of transistors in a chip. Equally important are the packaging solutions available that can enable fine line width, 3-dimensional interconnections and low-cost prototyping. Products which are ultra-compact with extremely high functionality are of clear benefit to companies wishing to remain competitive. The present invention will also enable system-on-package design and can be applied to produce conformal technological products.

Each patent and non-patent reference mentioned herein is hereby incorporated by reference in its entirety, as if the entire contents of each of these references were set forth herein.

The invention is illustrated by the non-limiting examples that follow below:

### Example 1

### Preparation of Substrate

This may be conducted as described by J. H.-G. Ng et al. (infra). A commercially available polyimide film (Kapton-HN, 50 μm thickness; structure:

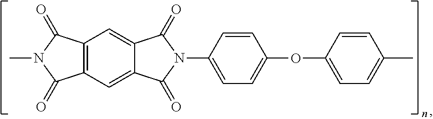

wherein n denotes the repeating unit in the polymer) as a substrate is treated with potassium hydroxide, which breaks certain bonds in the polyimide without severing the polymer chain and serves to provide potassium carboxylate moieties. The thus-treated film is then immersed in silver nitrate solution where an ion exchange between the silver and potassium ions naturally occurs. The Ag+ ion-doped polyimide substrate is then coated with a solution of chlorophyll-a in ethanol, typically by spin-coating. The chlorophyll-a was previously extracted with ethanol from spinach leaves.

The substrate is then exposed to a light source of wavelength that the chlorophyll-a will readily absorb, in this case a blue LED emitting in the 420-525 nm range, with a dominant wavelength of 470 nm. Silver atoms are thereby formed which agglomerate into silver nanoparticles. Agglomeration of the silver nanoclusters is achieved by annealing the substrate in an oven at 250° C. for 30 minutes. This process also allows the polyamic acid layer to re-imidise back into polyimide whilst encouraging diffusion and growth of the Ag particles towards the top surface. The silver particle aggregates formed on the substrate are isolated by the polyimide polymer matrix, but serve as suitable nucleation sites by acting as a catalyst seed layer for subsequent electroless metal crystal growth.

The following table presents results that demonstrate the utility of a chlorophyll extract coating to assist photoreduction of silver ions using a blue (470 nm) light source impinging onto an area of around 0.8 cm².

| | | | Chlorophyll | |
|---|---|---|---|---|
| 470 nm LED | | MPEG + ethanol | extract + | No |
| microbars array | Energy dose | (prior art) | ethanol | coating |
| 25 mW, 30 min | 45 J | No | Yes | No |
| 25 mW, 60 min | 90 J | No | Yes | No |
| 43 mW. 10 min | 25.8 J | No | Yes | No |
| 43 mW, 30 min | 77.4 J | No | Yes | No |
| 55 mW, 10 min | 33 J | No | Yes | No |
| 55 mW, 20 min | 66 J | No | Yes | No |
| 55 mW, 30 min | 99 J | No | Yes | No |

Yes = visible silver layer with prominent bright reflective appearance.
No = no visible pattern observable.

The silver patterns produced from the set of samples coated with chlorophyll extract in ethanol using different LED power and exposure times have different density of silver particle present. All these samples are able to initiate electroless plating quickly.

The shortest exposure time and lowest power used was 43 mW and 10 minutes. It was also the lowest energy dose used. From this result, it is expected that, using a light source at the same wavelength at power density of about 430 mW·cm⁻², similar patterns can be produced in about 1 minute.

This film with the silver seed layer now in place can then be plated by electroless plating to form conducting tracks (e.g. by using a conventional low pH formaldehyde based electroless copper solution containing 16 g·l⁻¹ CuSO₄, 48 g·l⁻¹ NaK-tartrate, 28 g·l⁻¹ NaOH and 12 ml·l⁻¹ aqueous solution (37.2 wt. %) of formaldehyde). With this arrangement, well-defined conductive copper may be electrolessly deposited only on the patterned silver seed layer.

### Example 2

### Preparation of Substrate

This may be conducted as described by J. H.-G. Ng et al. (infra). A commercially available poly(etherimide) film PEI (Ultem 1000 series, 50 & 75 μm thicknesses; structure:

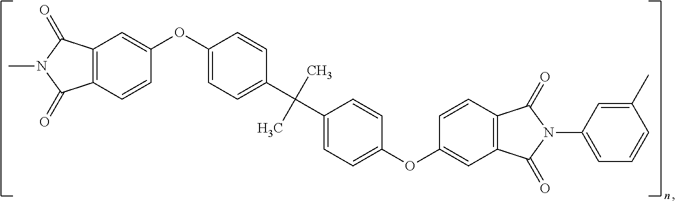

wherein n denotes the repeating unit in the polymer) as a substrate is treated as described in Example 1 and the chlorophyll-a-coated substrate exposed to the same light source described in Example 1.

Similar to Example 1, we have demonstrated the imide ring cleavage and ion-exchange and reduction process to be effective on the substrate used in this example. Both substrates contain an imide ring structure available for KOH modification. The one difference in the processing according to Example 2 was the use of increased temperature and/or KOH concentration requirements of the first imide-ring cleaving step. The substrate used in Example 2 shows greater resistance to KOH than that used in Example 1. Temperature is the main factor in this, with optimal results requiring 20 minutes of treatment at 80° C. using 15M KOH solution 5M KOH solution is also suitable but we find use of a higher temperature (of up to 100° C.) advantageous. Effecting such modifications are well within the capability of those of skill in the art.

### Example 3

### Experimental Results Using a Higher Intensity 470 nm Light Source than Used in Examples 1 and 2

| | | Silver adhesion | Silver adhesion to PEI |
|---|---|---|---|
| Exposure | Energy Dose | to Kapton-HN, | (Ultem 1000 series, 50 or |
| time | per cm² | 50 μm thickness | 75 μm thicknesses) |
| 20 s | 25.4 J | Good | Poor |
| 40 s | 50.8 J | Good | Good |
| 80 s | 101.6 J | Good | Good |
| 160 s | 203.2 J | Good | Good |

Illumination at wavelength of 470 nm showing the effect of incident energy dose on the adhesion of the plated electroless silver

| Scanning | Silver adhesion | Silver adhesion |
|---|---|---|
| Speed | to Kapton-HN, | to Kapton-HN, |
| (mm/s) | 50 μm thickness | 50 μm thickness |
| 0.1 | Good | Good |
| 0.5 | Good | Good |
| 1 | Good | Poor |

Scan speed tests using a 470 nm light source at 1270 mW/cm² and their relation to adhesion of electroless plated silver.

1. A method of reducing metal ions (3, 204) present on a substrate (100) comprising contacting the metal ions with a material (2, 201, 202) capable of reducing the metal ions to metal atoms (6, 9) upon exposure to visible light, and exposing the material to visible light (1) whereby to generate metal atoms from the metal ions.

2. The method of claim 1, wherein the substrate is a non-conductive organic polymer.

3. The method of claim 2, wherein the non-conductive organic polymer is a polyimide.

4. The method of claim 2, wherein the non-conductive organic polymer is a poly(etherimide).

5. The method of claim 1, in which the metal ions are of one or more of the type selected from the group consisting of silver, copper, gold, nickel, iron, tin, palladium, aluminium, zinc, lead or magnesium ions.

6. The method of claim 1, in which the metal ions are of silver and/or copper ions.

7. The method of claim 1, in which the metal ions are silver ions.

8. The method of claim 1, in which the material is a naturally derived visible light-activated photocatalyst found in plants, algae or bacteria, or a synthetic or partially synthetic visible light-activated photocatalyst.

9. The method of claim 8, in which the material is a chlorophyll, phycobilin or carotenoid.

10. The method of claim 1, in which the material is a tetrapyrrole-containing compound.

11. The method of claim 10, in which the tetrapyrrole-containing compound is a chlorin, corrin, phthalocyanine or porphyrin.

12. The method of claim 10, in which the tetrapyrrole-containing compound is a chlorophyll, chlorophyllin, pheophorbide, pheophytin or phycobilin.

13. The method of claim 10, in which the tetrapyrrole-containing compound comprises a free chlorin or a chlorin complexed to a metal salt.

14. The method of claim 10, in which the tetrapyrrole-containing compound is a metal (II) salt.

15. The method of claim 10, in which the tetrapyrrole-containing compound is a chlorophyll.

16. The method of claim 1, in which the exposing to visible light comprises exposure to a laser with wavelength band maxima in the blue and/or purple regions of the visible spectrum.

17. The method of claim 1, in which the exposing to visible light is maskless or employs a photomask.

18. (canceled)

19. (canceled)

20. A substrate obtainable according to a method of claim 1.

21. The method of claim 4, wherein the poly(etherimide) is selected from polyimide or polyetherimide.

22. The method of claim 14, wherein the metal (II) salt is selected from a magnesium, nickel, copper or zinc (II) salt.
